(19) United States
(12) Patent Application Publication
(10) Pub. No.: US 2024/0326136 A1
(43) Pub. Date: Oct. 3, 2024

(54) DELIMITATION DEVICE

(71) Applicants: Ceratizit Besigheim GmbH, Besigheim (DE); Ceratizit Balzheim GmbH & Co. KG, Balzheim (DE)

(72) Inventors: Roland Hoerl, Besigheim (DE); Philipp Wirth, Balzheim (DE); Adrian Wylezuch, Balzheim (DE)

(21) Appl. No.: 18/574,104

(22) PCT Filed: May 24, 2022
(86) PCT No.: PCT/EP2022/063953

§ 371 Date: Dec. 26, 2023

(30) Foreign Application Priority Data
Jun. 25, 2021 (EP) 21181628.5

(51) Int. Cl. B23B 51/10

(52) U.S. Cl. CPC B23B 51/104

(57) ABSTRACT

A delimitation device delimits a penetration depth of a cutting head into a workpiece. The delimitation device has a detent sleeve, a sleeve holder and a cutting head. The detent sleeve has a detent side for landing on a workpiece surface. The sleeve holder in relation to a rotation axis is mounted so as to be rotatable relative to the detent sleeve, and in relation to the rotation axis is fixed in an axial position relative to the detent sleeve and supports the detent sleeve. The cutting head during a rotation of the cutting head conjointly rotates with the sleeve holder in relation to the rotation axis and has at least one cutting edge. The sleeve holder has a positioning face, wherein the positioning face is disposed proximal to the detent side, transversely to the rotation axis. The cutting head contacts the positioning face.

The present invention relates to a delimitation device for delimiting a penetration depth of a cutting head into a workpiece, wherein the delimitation device has a detent sleeve, a sleeve holder and a cutting head; wherein the detent sleeve has a detent side for landing on a workpiece surface; wherein the sleeve holder in relation to a rotation axis is mounted so as to be rotatable relative to the detent sleeve, in relation to the rotation axis is fixed in an axial position relative to the detent sleeve and supports the detent sleeve; wherein the cutting head during a rotation of the cutting head conjointly rotates with the sleeve holder in relation to the rotation axis and has at least one cutting edge; wherein the cutting edge is disposed and configured proximal the detent side for cutting outside the detent sleeve.

DE 10 2014 115 768 B3 discloses a detent which is equipped with a countersinking tool.

In the detent known from DE 10 2014 115 768 B3, there is the requirement to precisely position the countersinking tool relative to the detent with less effort.

The object of the present invention lies in providing a delimitation device by way of which a cutting head is moved relative to the detent sleeve to a cutting position in a simple and simultaneously precise manner.

The technical object of the present invention is achieved by the subject matter of claim 1. Advantageous refinements of the invention are to be derived from the dependent claims, which can be freely combined with one another, and from the appended figures.

According to the present invention, the delimitation device for delimiting a penetration depth of a cutting head into a workpiece has a detent sleeve, a sleeve holder and a cutting head, wherein the detent sleeve has a detent side for landing on a workpiece surface; wherein the sleeve holder in relation to a rotation axis is mounted so as to be rotatable relative to the detent sleeve, in relation to the rotation axis is fixed in an axial position relative to the detent sleeve and supports the detent sleeve; wherein the cutting head during a rotation of the cutting head conjointly rotates with the sleeve holder in relation to the rotation axis and has at least one cutting edge; wherein the cutting edge is disposed and configured proximal to the detent side for cutting outside the detent sleeve; wherein the sleeve holder has a positioning face; wherein the positioning face is disposed towards the detent side, transversely to the rotation axis; wherein the cutting head contacts the positioning face.

The positioning face ensures that the cutting edge, in relation to the rotation axis, in an axial position is fixed against any movement relative to the detent sleeve into the detent sleeve. As a result, the cutting head is moved relative to the detent sleeve to a cutting position in a simple and simultaneously precise manner.

In this way, the cutting position is reached by the cutting head when the cutting head contacts the positioning face during assembling. The axial position of the positioning face thus establishes the axial position of the cutting head relative to the detent sleeve such that the cutting position is established in a particularly precise manner. In this way, it is only necessary for the spacing of the positioning face from the detent side to be established once, so as to be able to ensure that the cutting head is precisely positioned also in the event of repeated assembling.

The positioning face is preferably configured to be flat and disposed perpendicularly to the rotation axis, because this further improves the precision in terms of positioning the cutting head, as the positioning is independent of a rotary position of the cutting head in relation to the rotation axis.

The term “transversely to the rotation axis” means that the positioning face, when viewed in a longitudinal section which includes the rotation axis, forms an angle with the rotation axis, the angle being in the range of 105° to 75°, including 90°, and is measured proximal to the sleeve holder.

By virtue of the sleeve holder being fixed, in the axial position in relation to the rotation axis, relative to the detent sleeve, the positioning face is likewise axially fixed in this way. The fixing of the sleeve holder can take place in a force-fitting manner and/or form-fitting manner conjointly with a further component of the delimitation device.

The cutting head preferably has a mating face, wherein the mating face faces away from the detent side, is configured so as to follow the positioning face, and contacts the positioning face. As a result, the contact region between the positioning face and the cutting head is enlarged.

The rotation axis is understood to be a virtual rotation axis which runs through the respective interior of the sleeve holder and the detent sleeve, wherein the sleeve holder and the detent sleeve extend in each case along the rotation axis.

The detent sleeve is preferably a monolithic component, because such a component is easy to produce.

The sleeve holder is preferably a monolithic component, because such a component is easy to produce.

The sleeve holder is preferably configured as a sleeve because, as a result, a shaft element can be inserted into the sleeve holder so as to drive the cutting head, as a result of which the axial construction length of the sleeve holder is reduced.

According to one refinement, the sleeve holder has an insertion space and a sleeve holder wall, wherein the sleeve holder wall in relation to the rotation axis circumferentially surrounds the insertion space at least in portions; wherein the cutting head in portions is inserted into the insertion space; wherein the positioning face is a face of the sleeve holder wall. The sleeve holder wall improves the retention of the cutting head in the cutting position when under a load which is transverse to the rotation axis, and provides the positioning face in a space-saving manner.

According to one refinement, the positioning face is an end face of the sleeve holder wall. In this way, the positioning face is situated on at an easily accessible location proximal to the detent side, this improving both inspection and maintenance of the positioning face, benefitting precise positioning of the cutting head. The end face of the sleeve holder wall is preferably configured so as to be closed in a circular manner in relation to the rotation axis.

According to one refinement, the delimitation device has a drive shaft element, wherein the drive shaft element is in each case inserted into the sleeve holder and the cutting head so that the drive shaft element can set the cutting head in cutting head rotation; wherein the drive shaft element has a threaded portion; wherein the threaded portion engages in a thread of the cutting head. Owing to the threaded portion, the drive shaft element ensures that the cutting head, in relation to the rotation axis, is fixed against any axial movement away from the detent sleeve. The drive shaft element is a separate component in terms of the cutting head. The drive shaft element is in each case preferably reversibly and removably inserted into the sleeve holder and the cutting head, because this facilitates the replacement of the drive shaft element.

According to one refinement, the drive shaft element proximal to the detent side has a threaded head; wherein the threaded portion is configured in the region of the threaded head. In this way, a relatively short internal bore having an internal thread that follows the threaded portion proximal to the cutting head is sufficient for axially securing the cutting head in relation to the rotation axis, and thus maintaining contact between the positioning face and the cutting head even under axial loads in relation to the rotation axis. In the absence of a threaded head, the drive shaft element would have to be inserted deeper into the cutting head in order to get the threaded portion to engage with the cutting head, which would structurally weaken the cutting head.

According to one refinement, the cutting edge has a first cutting orbit which is measured radially in relation to the rotation axis; wherein the first cutting orbit is disposed proximal to the detent side outside the detent sleeve; wherein the cutting edge has a second cutting orbit which is measured radially in relation to the rotation axis; wherein the first cutting orbit is smaller than the second cutting orbit; wherein the second cutting orbit from the positioning face has an orbit spacing measured parallel to the rotation axis; wherein the detent side from the positioning face has a detent spacing measured parallel to the rotation axis; wherein the orbit spacing of the second orbit and the detent spacing are of identical size. By virtue of the cutting head contacting the positioning face, it is ensured that the orbit spacing of the second orbit and the detent spacing are of identical size. According to this refinement, the cutting position is defined by the orbit spacing of the second orbit. This advantageously dispenses with subsequent measuring to verify whether the orbit spacing of the second orbit is maintained as predefined after the cutting head has been assembled. The orbit spacing of the second orbit is maintained as soon as the cutting head contacts the positioning face.

According to one refinement, the cutting edge runs so as to be straight or curved between the first cutting orbit and the second cutting orbit. As a result, the cutting head during the cutting head rotation can generate a bevel in a workpiece that follows the profile of the cutting edge. Because the two cutting orbits are held precisely in position in relation to the detent side by the positioning face, a bevel opening angle can be maintained in a likewise precise manner. The bevel opening angle, when viewed in a longitudinal section, is measured by the delimitation device, wherein the rotation axis lies in the longitudinal section, the rotation axis is a virtual leg of the bevel opening angle proximal to the sleeve holder, and the cutting edge in the region between the two cutting orbits is the other leg of the bevel opening angle proximal to the sleeve holder; wherein the bevel opening angle is measured proximal to the sleeve holder. The bevel opening angle is preferably in the range from 5° to 85°, because this range is particularly expedient for countersinking customary screw heads.

According to one refinement, the delimitation device has a plurality of dogs; wherein the dogs in the region of the sleeve holder wall are disposed proximal to the insertion space; wherein at least two dogs of the dogs contact the cutting head for rotational entrainment. The dogs ensure that the sleeve holder is more precisely coupled to the cutting head for rotation. The dogs protrude into the insertion space, preferably in the region of the detent sleeve.

According to one refinement, at least one dog of the dogs is a monolithic portion of the sleeve holder wall. As a result, the dog, which is a monolithic portion of the sleeve holder wall, is particularly well secured against radial displacement in relation to the rotation axis, this rendering the transmission of rotation even more stable, in particular under vibrations of the delimitation device. Accordingly, it is particularly advantageous for at least three dogs of the dogs to be in each case configured and disposed as a monolithic portion of the sleeve holder wall, because the rotational entrainment can take place so as to be statically determined as a result.

According to one refinement, the sleeve holder wall in the circumferential direction in relation to the rotation axis has a plurality of concavely curved centring portions; wherein at least two centring portions of the centring portions centre the cutting head in relation to the rotation axis. The centring portions, in relation to the rotation axis, in portions can in each case follow a spiral in the same circumferential direction, i.e. when viewed towards the detent side in the clockwise or anticlockwise direction, wherein each spiral has a centre which lies on the rotation axis in each case. In this way, the spacing of each centring portion from the rotation axis increases when the spiral is followed in a direction of the spiral away from the spiral centre. The centring portions spiralized in such a way can centre the cutting head under a clamping action in that the cutting head, while in contact with at least two centring portions of the centring portions, is rotated counter to the direction of the spiral. The centring portions here preferably each follow an Archimedean spiral, because such a spiral provides a smooth and thus gentle increase in the clamping forces, this reducing the load on the sleeve holder wall.

However, the centring portions can in each case also follow a circle, wherein each circle has a centre which lies on the rotation axis. Such centring portions are particularly easy to produce.

The centring portions, when viewed in a longitudinal section in which the rotation axis lies, in each case lying mutually opposite in pairs, can form a V-shape, wherein a virtual tip of the V-shape faces away from the detent side. As a result, the cutting head can be reversibly and releasably clamped in the axial direction between the centring portions.

According to one refinement, the centring portions and the dogs, when viewed in a cross section perpendicular to the rotation axis, in the circumferential direction in relation to the rotation axis are disposed in a mutually alternating manner. As a result, the dogs and the centring portions have in each case an effective region which lies in the same cross section, this reducing the axial construction length of the sleeve holder in relation to the rotation axis.

According to one refinement, at least three dogs of the dogs and at least three centring portions of the centring portions are provided; wherein the cutting head in the cross section proximal to the sleeve holder wall has an external contour; wherein the external contour has the shape of a triangle having straight edges and having radiused corners; wherein each corner of the corners contacts in each case one centring portion; wherein each edge of the edges contacts in each case one dog of the dogs. This is a particularly expedient refinement, because the respective three dogs and three centring portions provided in such a way ensure a statically determined rotational entrainment, or centring, of the cutting head, so that the rotational entrainment of the cutting head and the centring are in each case provided in a particularly precise manner.

According to one refinement, the drive shaft element has a shaft protrusion which projects radially in relation to the rotation axis; wherein the sleeve holder is disposed between the cutting head and the shaft protrusion; wherein the sleeve holder contacts the shaft protrusion under axial pre-loading applied by the cutting head. The shaft protrusion, in relation to the rotation axis, fixes the sleeve holder in the axial direction relative to the drive shaft element.

According to one refinement, the delimitation device has a rotary bearing unit; wherein the rotary bearing unit has an inner bearing race, and an outer bearing race, and a plurality of rolling members; wherein the sleeve holder supports the inner bearing race so as to be conjointly rotatable in a synchronous manner in relation to the rotation axis; wherein the detent sleeve supports the outer bearing race so as to be conjointly rotatable in a synchronous manner in relation to the rotation axis; wherein the rolling members are disposed between the inner bearing race and the outer bearing race; wherein the rolling members contact in each case the inner bearing race and the outer bearing race. The rotary bearing unit reduces the friction between the detent sleeve and the sleeve holder during the cutting head rotation. The inner bearing race, the outer bearing race, and the rolling members preferably form a radial bearing in relation to the rotation axis. The rolling members can in each case be configured as balls, cylinders, or cones.

The delimitation device preferably has a further rotary bearing unit, wherein the further rotary bearing unit in relation to the rotation axis, is axially spaced apart from the rotary bearing unit; wherein the further rotary bearing unit has a further inner bearing race, a further outer bearing race, and a plurality of further rolling members; wherein the sleeve holder supports the further inner bearing race so as to be conjointly rotatable in a synchronous manner in relation to the rotation axis; wherein the detent sleeve supports the further outer bearing race so as to be conjointly rotatable in a synchronous manner in relation to the rotation axis; wherein the further rolling members are disposed between the further inner bearing race and the further outer bearing race; wherein the further rolling members contact in each case the further inner bearing race and the further outer bearing race. The further rotary bearing unit is preferably constructed in a manner analogous to that of the rotary bearing unit. The further rotary bearing unit renders the rotatable mounting of the sleeve holder more stable in relation to bending loads transverse to the rotation axis.

According to one refinement, the delimitation device has a guide sleeve; wherein the detent sleeve is inserted into the guide sleeve; wherein the guide sleeve is connected to the detent sleeve so as to be conjointly rotatable in a synchronous manner in relation to the rotation axis; wherein the guide sleeve proximal to the detent side has a guide detent side; wherein the guide sleeve in relation to the rotation axis is mounted so as to be axially displaceable relative to the detent sleeve, so that the guide sleeve is adjustable from an initial position to a terminal position; wherein the guide detent side in the initial position protrudes in the axial direction beyond the detent side in relation to the rotation axis; wherein the guide detent side in the terminal position at least in portions terminates flush with the detent side; wherein the guide sleeve is axially preloaded while moving from the initial position to the terminal position. The guide sleeve ensures that the detent sleeve achieves contact with the workpiece face in a more stable manner from the detent side, because the guide detent side contacts the workpiece surface before the detent side. In this way, the guide detent side is positioned for example centrically by way of a bore, while the guide detent side is in contact with a region surrounding the bore. This positioning likewise positions the detent side centrically, so that the cutting head can centrically machine the bore.

According to one refinement, the detent sleeve has at least one alignment bore, and the sleeve holder has an alignment bore, wherein the alignment bore of the detent sleeve interrupts the detent sleeve and can be moved so as to be congruent with the alignment bore of the sleeve holder while the detent sleeve rotates relative to the sleeve holder in relation to the rotation axis. When the alignment bores have been brought to congruence in such a way, a blocking element can be introduced into the alignment bores so that any rotation of the detent sleeve relative to the sleeve holder in relation to the rotation axis is blocked. In such a blocked state, the cutting head can be screwed to the threaded head in a particularly simple manner. This blocking action is even further improved when the detent sleeve has a further alignment bore and the sleeve holder has a further alignment bore; wherein the further alignment bore of the detent sleeve can be moved so as to be congruent with the further alignment bore of the sleeve holder while the detent sleeve rotates relative to the sleeve holder in relation to the rotation axis. In this way, a further blocking element can be used for blocking, or the blocking element can be configured in the shape of a tuning fork and in this way be introduced into the alignment bores by way of a respective prong of the tuning fork.

Further advantages and expedient aspects of the invention are derived by means of the description hereunder of exemplary embodiments with reference to the appended figures.

In the Figures:

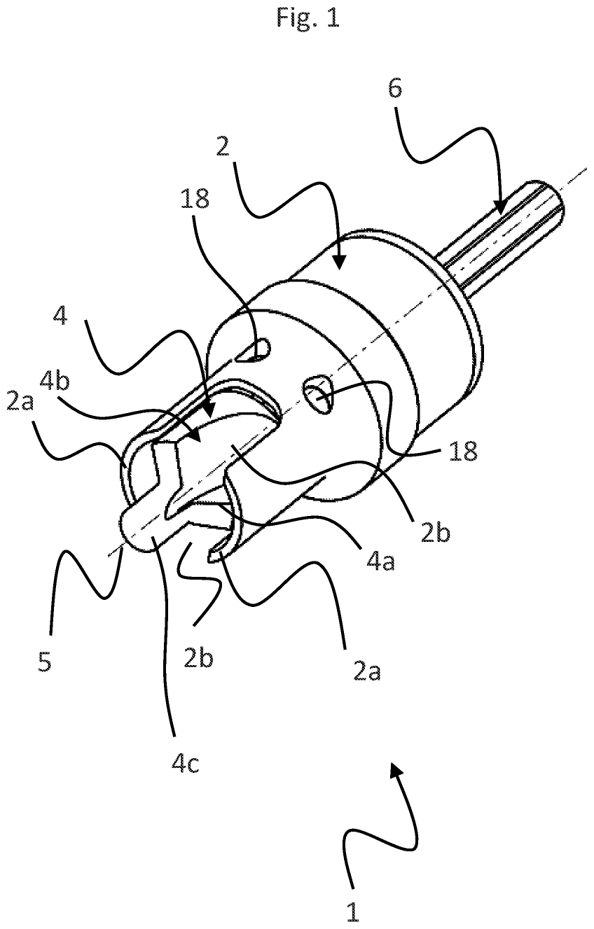

FIG. 1: shows a schematic perspective illustration of a delimitation device;

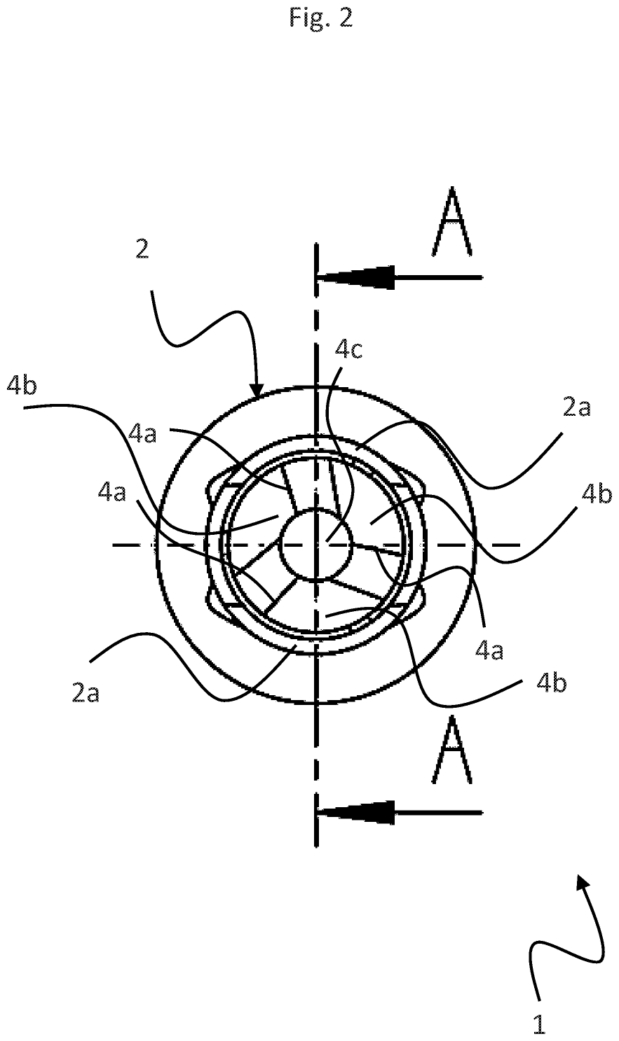

FIG. 2: shows a schematic illustration of an end-side view of the delimitation device of FIG. 1;

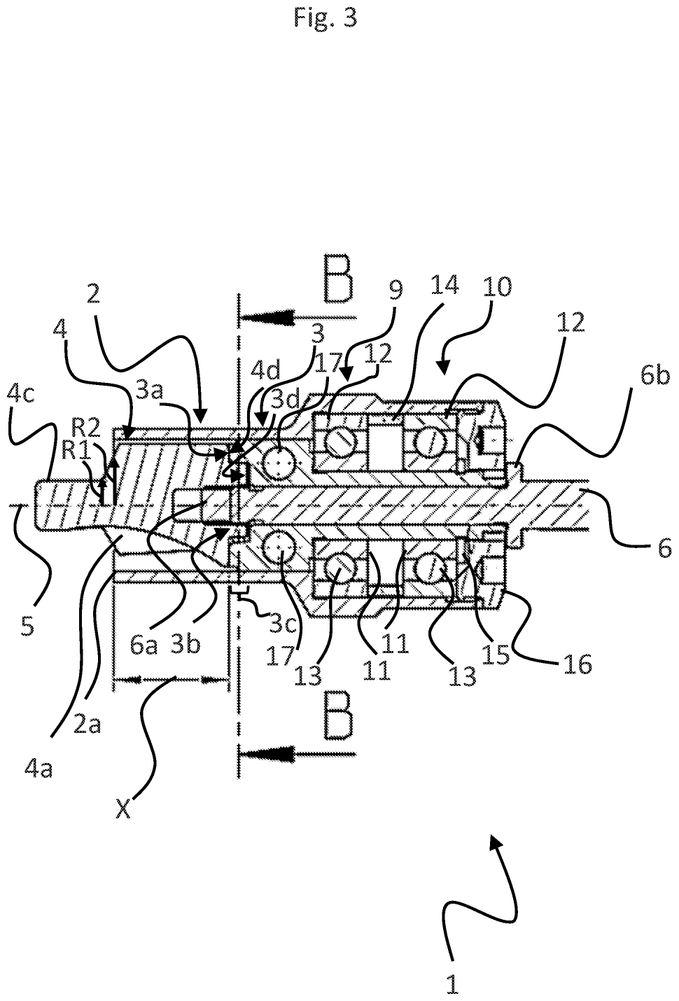

FIG. 3: shows a sectional illustration according to the section lines A-A in FIG. 2;

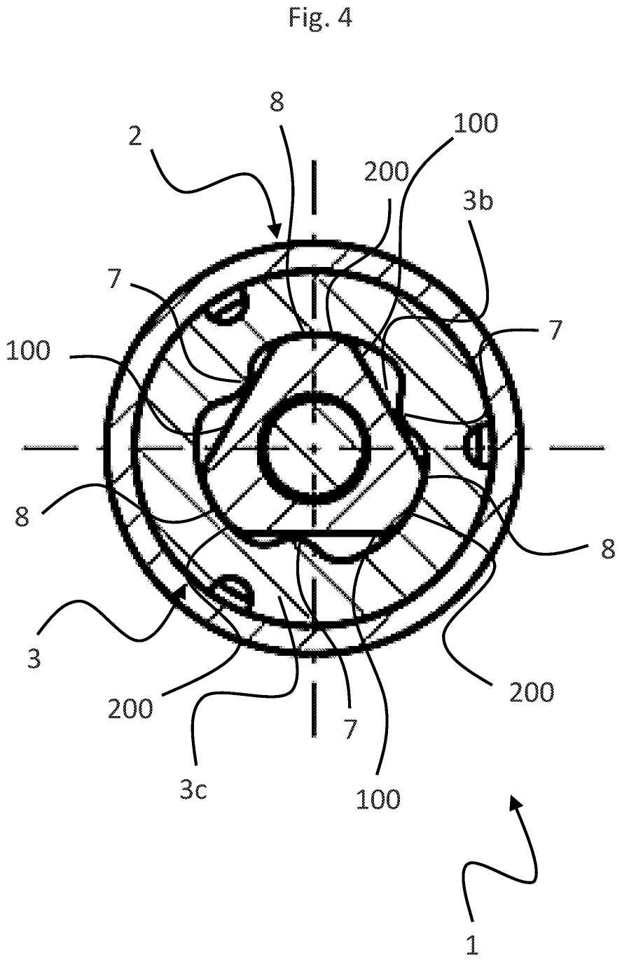

FIG. 4: shows a sectional illustration according to the lines B-B in FIG. 3;

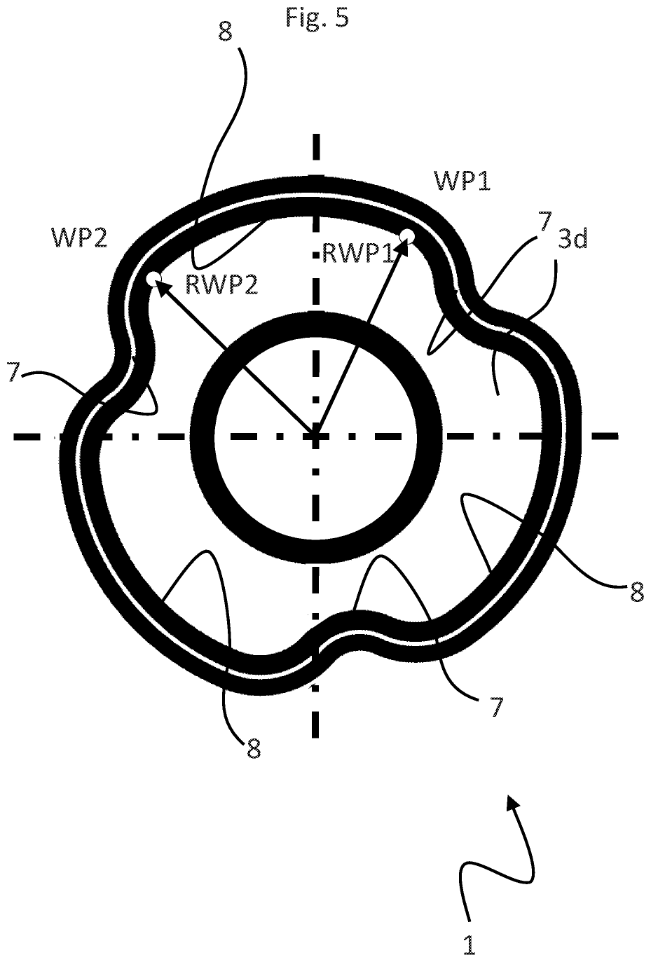

FIG. 5: shows the end-side view of FIG. 2, without the cutting head and the detent sleeve; and

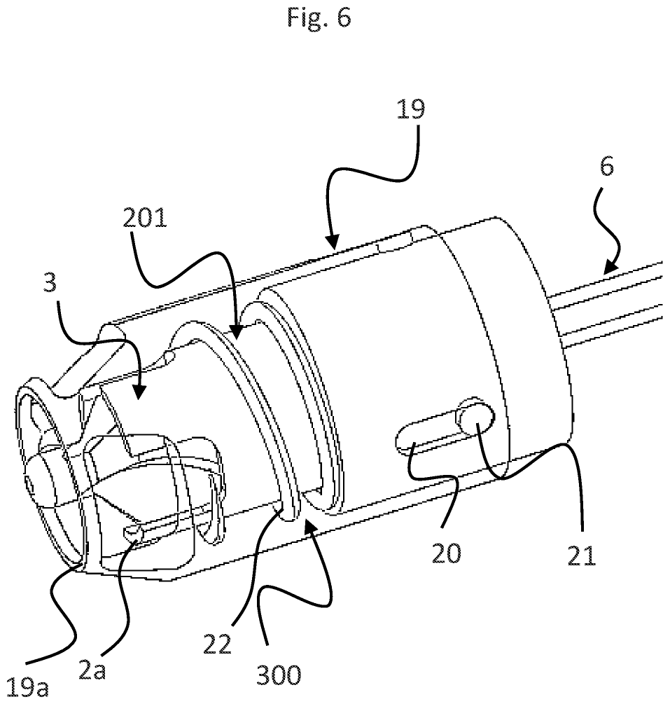

FIG. 6: shows a schematic perspective illustration of a further delimitation device.

FIGS. 1 to 6 show an illustration of a delimitation device 1.

The delimitation device 1 has a detent sleeve 2, a sleeve holder 3, and a cutting head 4.

The detent sleeve 2 has a flat detent side 2a for landing the detent sleeve 2 on a workpiece face not illustrated. The detent side 2a is a flat end side of the detent sleeve 2, so that the detent sleeve 2 can land on the workpiece face so as to be stable in terms of tilting. The detent sleeve 2 has two U-shaped clearances 2b. The U-shaped clearances 2b interrupt the detent side 2a and ensure that chips can be laterally removed from the detent sleeve 2. The U-shaped clearances 2b thus prevent any accumulation of chips in the detent sleeve 2.

The sleeve holder 3 in relation to a rotation axis 5 is mounted so as to be rotatable relative to the detent sleeve 2, and in relation to the rotation axis 5 is fixed in an axial position relative to the detent sleeve 2 and thus to the detent side 2a. When landed on the workpiece face, the detent sleeve 2 is stationary while the sleeve holder 3 is rotated in relation to the rotation axis 5.

The sleeve holder 3 supports the detent sleeve 2 so as to be reversibly released.

The cutting head 4 during a rotation of the cutting head rotates conjointly with the sleeve holder 3 in relation to the rotation axis 5. In this way, in the state landed on the workpiece face, is also stationary relative to the cutting head 4 while the sleeve holder 3 rotates in relation to the rotation axis 5.

The cutting head 4 has three cutting edges 4a, wherein each cutting edge 4a in portions protrudes from the detent sleeve 2 proximal to the detent side 2a, so that each cutting edge 4a is disposed so as to actively cut. The cutting edges 4a are in each case straight and run in each case at an angle in relation to the rotation axis 5, wherein the angle is measured proximal to the sleeve holder 3 and by way of example is 60°. This angle can also be referred to as the bevel opening angle. This is because the cutting edges 4a, when the cutting edges 4a enter a workpiece, generate a bevel encircling the rotation axis 5 during a cutting head rotation.

However, a larger or smaller number of cutting edges 4a, and/or a bevel opening angle deviating from 60°, are/is also conceivable and possible.

The cutting head 4 furthermore has three chip spaces 4b. The chip spaces 4b in relation to the rotation axis 5 are disposed so as to alternate with the cutting edges 4a in the circumferential direction, so that each cutting edge 4a has one chip space 4b assigned thereto for discharging chips.

The cutting head 4 furthermore has a centring tip 4c proximal to the detent side 2a. The centring tip 4c ensures that the cutting head 4 can be better introduced centrically into a bore already generated.

The cutting head 4 contacts a positioning face 3a of the sleeve holder 3. The positioning face 3a ensures that the cutting edges 4a, in relation to the rotation axis 5, in the axial position shown in FIG. 3 are fixed against any movement relative to the detent sleeve 2 further into the detent sleeve 2.

The positioning face 3a is disposed so as to be perpendicular to the rotation axis 5 proximal to the detent side 2a. Furthermore, the positioning face 3a is configured so as to be closed in an annular manner in relation to the rotation axis 5, has the rotation axis 5 as a central axis, and is of a flat configuration.

The cutting head 4 proximal to the sleeve holder 3 has a mating face 4d. The mating face 4d is configured so as to follow the positioning face 3a and contacts the positioning face 3a.

The sleeve holder 3 has an insertion space 3b and a sleeve holder wall 3c. The sleeve holder wall 3c surrounds the insertion space 3b so as to be circumferentially closed in relation to the rotation axis 5. The cutting head 4 in portions is inserted into the insertion space 3b so that the cutting head 4 is laterally stabilized. The positioning face 3a is an end face of the sleeve holder wall 3c proximal to the detent side 2a.

The insertion space 3b has a base face 3d, wherein the cutting head 3 maintains a gap towards the base face 3. It is ensured in this way that the axial position of the cutting head 4 in relation to the rotation axis 5 is defined by the axial position of the positioning face 3a. The base face 3d, measured parallel to the rotation axis 5, has a larger spacing from the detent side 2a than the positioning face 3a.

The delimitation device 1 furthermore has a drive shaft element 6. The drive shaft element 6 is in each case inserted into the sleeve holder 3 and the cutting head 4, so that the drive shaft element 6 sets the cutting head 4 in cutting head rotation when the drive shaft element 6 is rotationally driven in relation to the rotation axis 5.

The drive shaft element 6 has a threaded head 6a. The threaded head 6a is screwed into the cutting head 4 so that the mating face 4c maintains contact with the positioning face 3a when under loads in the axial direction away from the detent sleeve 2 in relation to the rotation axis 5.

The drive shaft element 6 furthermore has a shaft protrusion 6b which projects radially in relation to the rotation axis 5. The sleeve holder 3 contacts the shaft protrusion 6b so that the sleeve holder 3 is axially secured by the shaft protrusion 6b.

The fact that the positioning face 3a ensures that the cutting head position is maintained is particularly salient in terms of the disposal of the cutting edges 4a relative to the detent side 2a.

Each cutting edge 4a thus has a first cutting orbit which is measured radially in relation to the rotation axis 5 and of which the radius R1 is shown for one cutting edge 4a of the cutting edges 4a in FIG. 3. The first cutting orbit, and thus R1, are disposed so as to stand alone outside the detent sleeve 2.

Each cutting edge 4a furthermore has a second cutting orbit which is measured radially in relation to the rotation axis and of which the radius R2 is shown for one cutting edge 4a of the cutting edges 4a in FIG. 3.

The first cutting orbit, or R1, is smaller than the second cutting orbit, or R2, respectively. The first cutting orbit, or R1, and the second cutting orbit, or R2, have in each case a spacing from the positioning face 3a measured parallel to the rotation axis 5, respectively. The spacing such measured for the second cutting orbit, or R2, is provided with the reference sign X in FIG. 3 and may also be referred to as the orbit spacing from the second cutting orbit, or R2.

The positioning face 3a has a spacing from the detent side 2a as measured parallel to the rotation axis 5, whereby the detent side 2a and the positioning face 3a are each oriented perpendicular to the rotation axis 5. The spacing such measured for the positioning face 3a can also be referred to as the detent spacing, respectively, wherein the detent spacing and the spacing X are of identical size, as is shown in FIG. 3.

Because the second cutting orbit, or R2, is larger than the first cutting orbit, or R1, it is ensured a bore is bored to the maximum below the second cutting orbit, or R2, respectively, when the cutting head 4 contacts the positioning face 3a. As soon as this contact is established, which can be easily verified in that the cutting head 4, upon contact with the positioning face 3a, cannot be moved deeper into the detent sleeve 2, bores can be bored while adhering to a maximum boring diameter of 2×R2. Any subsequent axial measuring of the cutting head 4a in relation to the detent sleeve 2 is dispensed with because the mechanical contact between the mating face 4d and the positioning face 3a is sufficient in order to be able to ensure that the spacing X is maintained.

FIG. 4, which is an illustration of a cross section perpendicular to the rotation axis 5, and viewed in the direction parallel to the rotation axis 5, and FIG. 5, which is an illustration of the delimitation device 1 without the cutting head 4, viewed in the direction parallel to the rotation axis 5, show in each case that the delimitation device 1 has three dogs 7, wherein the dogs 7 are disposed in the region of the sleeve holder wall 3c proximal to the insertion space 3b.

The dogs 7 contact the cutting head 4 for rotational entrainment, as is shown in FIG. 4. The dogs 7 are in each case configured as a monolithic and convex portion of the sleeve holder wall 3c, as is shown in FIG. 4.

FIG. 4 and FIG. 5 show that the sleeve holder wall 3c has three concave curved centring portions 8 in the circumferential direction in relation to the rotation axis 5. FIG. 4 shows that the centring portions 8 centre the cutting head 4 in relation to the rotation axis 5.

FIG. 6, using the example of a centring portion 8, in a manner exemplary of all centring portions 8, shows that the centring portions 8 maintain in each case a variable radial spacing from the rotation axis 5, wherein the sleeve holder wall 3c in the region of the centring portions 8 has in each case two curvature reversal points WP1 and WP2. The sleeve holder wall 3c at each curvature reversal point WP1 and WP2 transitions from the convex curvature of the sleeve holder wall 3c, generated in each case by the dogs 7, to the concave curvature of the sleeve holder wall 3c, generated by the centring portions 8. In the circumferential direction in relation to the rotation axis 5, the spacing of the centring portions 8 measured radially to the rotation axis 5 decreases in each case from RWP1 at WP1 to RWP2 at WP2. The centring portions 8 shaped in such a way exert in each case a clamping force on the cutting head 4 which acts circumferentially in relation to the rotation axis 5; the centring portions 8 are in each case equally curved in the circumferential direction in relation to the rotation axis 5, and are radially spaced apart from the rotation axis 5.

However, it is also conceivable and possible that the radial spacing of the centring portions 8 is in each case constant in the circumferential direction in relation to the rotation axis 5, the centring portion 8 thus lying in each case conjointly on a virtual circle, the centre of the latter lying on the rotation axis 5.

FIG. 4 shows that the centring portions 8 and the dogs 7 in the cross section according to FIG. 4 are disposed so as to alternate with one another in the circumferential direction in relation to the rotation axis 5.

The cutting head 4 in the cross section according to FIG. 4, has an external contour proximal to the sleeve holder wall 3c, wherein the external contour has the shape of a triangle having straight edges 100 and having radiused corners 200. Each corner 200 contacts in each case one centring portion 8, and each edge 100 contacts in each case one dog 8.

However, a different external contour of the cutting head 4, in which the edges 100 can be curved, is also conceivable and possible.

The delimitation device 1 furthermore has a rotary bearing unit 9 and a further rotary bearing unit 10 which is constructed in a manner analogous to that of the rotary bearing unit 9, as is shown in FIG. 3. The rotary bearing units 9 and 10 have in each case an inner bearing race 11, an outer bearing race 12, and a plurality of rolling members 13.

The sleeve holder 3 supports the inner bearing races 11 so as to be conjointly rotatable in a synchronous manner in relation to the rotation axis 5. The detent sleeve 2 supports the outer bearing races 12 so as to be conjointly rotatable in a synchronous manner in relation to the rotation axis 5. The rolling members 13 are in each case disposed between the inner bearing race 11 and the outer bearing race 12, wherein the rolling members 13 contact in each case the inner bearing race 11 and the outer bearing race 13.

A spacer ring 14 is disposed between the outer bearing races 12 proximal to the detent sleeve 2, wherein the detent sleeve 2 supports the spacer ring 14 so as to be conjointly rotatable in a synchronous manner. The spacer ring 14 blocks a mutually converging axial movement of the two outer bearing races 14 in relation to the rotation axis 5.

The outer bearing race 12 of the rotary bearing unit 9 proximal to the detent side 2a contacts the detent sleeve 2 so that the outer bearing race 12 of the rotary bearing unit 9 in relation to the rotation axis 5 is clamped axially on both sides by the detent sleeve 2 and the spacer ring 14.

The inner bearing race 11 of the rotary bearing unit 10 proximal to the shaft protrusion 6b contacts a tension ring 15 incorporated in the drive shaft element 6, so that a movement of the inner bearing race 11 of the rotary bearing unit 10 in the axial direction away from the detent side 2a in relation to the rotation axis 5 is blocked.

The outer bearing race 12 of the rotary bearing unit 10 proximal to the shaft protrusion 6b contacts a bearing cover 16 of the delimitation device 1 so that the outer bearing race 12 of the rotary bearing unit 10 in relation to the rotation axis 5 is clamped axially on both sides by the spacer ring 14 and the bearing cover 16.

The sleeve holder 3 has two alignment bores 17, as is shown in FIG. 3. The detent sleeve 2 has two alignment bores 18, as is shown in FIG. 1. The alignment bores 18 interrupt the detent sleeve 2 so that the alignment bores 18 are in each case configured as through-bores.

The alignment bores 18 can be brought to congruence with the alignment bores 17 while the detent sleeve 5 rotates relative to the sleeve holder 3 in relation to the rotation axis 5, so that a first alignment bore 18 of the alignment bores 18 superimposes a first alignment bore 17 of the alignment bores 17, and a second alignment bore 18 of the alignment bores 18 superimposes a second alignment bore 17 of the alignment bores 17. A blocking element in the shape of a tuning fork can be introduced into the alignment bores 17 and 18 aligned in such a way, so that any relative rotation of the detent sleeve 2 relative to the sleeve holder 3 in relation to the rotation axis 5 is blocked. In the state in which the delimitation device 1 is blocked in such a way, the cutting head 2 can be particularly easily screwed to the threaded head 6a.

FIG. 6 shows a delimitation device 300. The delimitation device 300 is constructed in a manner analogous to that of the delimitation device 1 so that the same reference signs are used for the same components.

The delimitation device 300 differs from the delimitation device 1 in that the delimitation device 300 has a guide sleeve 19 and a spring 22, and in that the delimitation device 300 has a detent sleeve 201 and one which in contrast to the detent sleeve 2 has two pins 21, wherein the pins 21 project in each case radially outward in relation to the rotation axis 5; only the one pin 21 of the pins 21 is shown in FIG. 6.

The detent sleeve 201 is inserted into the guide sleeve 19, wherein the guide sleeve 19 is connected to the detent sleeve 201 so as to be conjointly rotatable in a synchronous manner in relation to the rotation axis 5, in that the guide sleeve 19 has two slots 20 which extend along the rotation axis 5, one pin 21 of the pins 21 engaging in each case in one of the slots 20.

The guide sleeve 19 proximal to the detent side 2a has a guide detent side 19a, and by way of the described engagement of the pins 21 in the slots 20 is mounted so as to be guided to be axially displaceable relative to the detent sleeve 2 in relation to the rotation axis 5, so that the guide sleeve 19 is adjustable in a guided manner from an initial position illustrated in FIG. 6 to a terminal position.

In the terminal position, the pins 21 are situated at the other end of the slots 20 according to FIG. 6, so that the guide detent side 19a in the terminal position terminates flush with the detent side 2a.

In the initial position shown in FIG. 6, the guide detent side 19a protrudes beyond the detent side 2a.

The spring 22, which is implemented as a spiral spring, contacts the detent sleeve 201 proximal to the pins 21, and the guide sleeve 19 proximal to the guide detent side 19a, so that the spring 22, when the guide sleeve 19a moves from the initial position to the terminal position, is compressed in the axial direction in relation to the rotation axis 5. As a result, the guide sleeve during the movement from the initial position to the terminal position is axially preloaded so that the detent side 2a is moved towards the workpiece face, not illustrated, in a checked manner.

However, the invention is not limited to the delimitation device 1 shown in FIGS. 1 to 5 and the delimitation device 300 shown in FIG. 6. It is in particular also conceivable and possible that a number of cutting edges 4a different from three is in each case provided; that the positioning face is curved concavely away from the detent side 2a or concavely towards the detent side 2a; that the detent side 2a is closed in an annular manner in relation to the rotation axis 5; that the cutting edges 4a have in each case a different bevel opening angle; and that a spring other than the spring 22 is provided.

1-15. (canceled)

16. A delimitation device for delimiting a penetration depth of a cutting head into a workpiece, the delimitation device comprising:
a detent sleeve having a detent side for landing on a workpiece surface;
a sleeve holder, wherein said sleeve holder in relation to a rotation axis is mounted so as to be rotatable relative to said detent sleeve, and in relation to the rotation axis is fixed in an axial position relative to said detent sleeve and supports said detent sleeve;
a cutting head, wherein said cutting head during a rotation of said cutting head conjointly rotates with said sleeve holder in relation to the rotation axis and has at least one cutting edge, wherein said at least one cutting edge is disposed and configured proximal to said detent side for cutting outside said detent sleeve; and
said sleeve holder further having a positioning face disposed proximal to said detent side, transversely to the rotation axis, wherein said cutting head contacts said positioning face.

17. The delimitation device according to claim 16, wherein:
said sleeve holder has an insertion space and a sleeve holder wall, wherein said sleeve holder wall in relation to the rotation axis circumferentially surrounds said insertion space at least in portions;
said cutting head in portions is inserted into said insertion space; and
said positioning face is a face of said sleeve holder wall.

18. The delimitation device according to claim 17, wherein said positioning face is an end face of said sleeve holder wall.

19. The delimitation device according to claim 17,
wherein said cutting head has a thread; and
further comprising a drive shaft, said drive shaft is in each case inserted into said sleeve holder and said cutting head so that said drive shaft sets said cutting head in cutting head rotation, wherein said drive shaft has a threaded portion and said threaded portion engages in said thread of said cutting head.

20. The delimitation device according to claim 19, wherein said drive shaft is proximal to said detent side and has a threaded head, said threaded portion is configured in a region of said threaded head.

21. The delimitation device according to claim 16, wherein:
said at least one cutting edge has a first cutting orbit which is measured radially in relation to the rotation axis, said first cutting orbit is disposed proximal to said detent side outside said detent sleeve;
said cutting edge has a second cutting orbit which is measured radially in relation to the rotation axis;
said first cutting orbit is smaller than said second cutting orbit;
said second cutting orbit from said positioning face has an orbit spacing measured parallel to the rotation axis;
said detent side from said positioning face has a detent spacing measured parallel to the rotation axis; and
said orbit spacing of said second orbit and said detent spacing are of identical size.

22. The delimitation device according to claim 21, wherein said at least one cutting edge runs so as to be straight or curved between said first cutting orbit and said second cutting orbit.

23. The delimitation device according to claim 17, further comprising a plurality of dogs, said dogs in a region of said sleeve holder wall are disposed proximal to said insertion space, wherein at least two of said dogs contact said cutting head for rotational entrainment.

24. The delimitation device according to claim 23, wherein at least one of said dogs is a monolithic portion of said sleeve holder wall.

25. The delimitation device according to claim 23, wherein said sleeve holder wall has a plurality of concavely curved centring portions in a circumferential direction in relation to the rotation axis, wherein at least two of said concavely curved centring portions center said cutting head in relation to the rotation axis.

26. The delimitation device according to claim 25, wherein said concavely curved centring portions and said dogs, when viewed in a cross section perpendicular to the rotation axis, in a circumferential direction in relation to the rotation axis are disposed in a mutually alternating manner.

27. The delimitation device according to claim 26, wherein:
at least three of said dogs and at least three of said concavely curved centring portions are provided;
said cutting head in a cross section proximal to said sleeve holder wall has an external contour;
said external contour has a shape of a triangle having straight edges and having radiused corners, wherein each of said radiused corners contacts in each case one of said concavely curved centring portions; and
each edge of said straight edges contacts in each case one dog of said dogs.

28. The delimitation device according to claim 19, wherein:
said drive shaft has a shaft protrusion which projects radially in relation to the rotation axis;
said sleeve holder is disposed between said cutting head and said shaft protrusion; and
said sleeve holder contacts said shaft protrusion (6a) under axial pre-loading applied by said cutting head.

29. The delimitation device according to claim 16,
further comprising a rotary bearing unit, said rotary bearing unit having an inner bearing race, an outer bearing race, and a plurality of rolling members;
wherein said sleeve holder supports said inner bearing race so as to be conjointly rotatable in a synchronous manner in relation to the rotation axis;
wherein said detent sleeve supports said outer bearing race so as to be conjointly rotatable in a synchronous manner in relation to the rotation axis;
wherein said rolling members are disposed between said inner bearing race and said outer bearing race; and
wherein said rolling members contact in each case said inner bearing race and said outer bearing race.

30. The delimitation device according to claim 16,
further comprising a guide sleeve;
wherein said detent sleeve is inserted into said guide sleeve;
wherein said guide sleeve is connected to said detent sleeve so as to be conjointly rotatable in a synchronous manner in relation to the rotation axis;
wherein said guide sleeve is proximal to said detent side and has a guide detent side;
wherein said guide sleeve in relation to the rotation axis is mounted so as to be axially displaceable relative to said detent sleeve, so that said guide sleeve is adjustable from an initial position to a terminal position;
wherein said guide detent side in the initial position protrudes in the axial direction beyond said detent side in relation to the rotation axis;
wherein said guide detent side in the terminal position at least in portions terminates flush with said detent side; and
wherein said guide sleeve is axially preloaded while moving from the initial position to the terminal position.
